(19) United States
(12) Patent Application Publication
(10) Pub. No.: US 2022/0076179 A1
(43) Pub. Date: Mar. 10, 2022

(54) CONTROL DEVICE, SYSTEM, VEHICLE, AND SERVICE SUPPORT METHOD

(71) Applicant: TOYOTA JIDOSHA KABUSHIKI KAISHA, Toyota-shi Aichi-ken (JP)

(72) Inventors: Kotaro Okabe, Ichikawa-shi Chiba-ken (JP); Tomo Sasaki, Toyota-shi Aichi-ken (JP); Koichi Suzuki, Miyoshi-shi Aichi-ken (JP); Genshi Kuno, Kasugai-shi Aichi-ken (JP); Koichi Hirano, Toyota-shi Aichi-ken (JP); Makoto Yamazaki, Nagoya-shi Aichi-ken (JP)

(73) Assignee: TOYOTA JIDOSHA KABUSHIKI KAISHA, Toyota-shi Aichi-ken (JP)

(21) Appl. No.: 17/465,117

(22) Filed: Sep. 2, 2021

(30) Foreign Application Priority Data
Sep. 4, 2020 (JP) 2020-149364

(51) Int. Cl. G06Q 10/06

(52) U.S. Cl. CPC G06Q 10/06312; G06Q 10/06315; G06Q 10/063114

(57) ABSTRACT

A control device includes a control unit configured to acquire status data indicating status of a first facility and to determine according to the status indicated by the acquired status data whether to send resources possessed by a second facility different from the first facility from the second facility to the first facility as resources to be used to provide a service at the first facility.

### CROSS-REFERENCE TO RELATED APPLICATION

This application claims priority to Japanese Patent Application No. 2020-149364 filed on Sep. 4, 2020, incorporated herein by reference in its entirety.

### BACKGROUND

### 1. Technical Field

The present disclosure relates to control devices, systems, vehicles, and service support methods.

### 2. Description of Related Art

Japanese Unexamined Patent Application Publication No. 2015-149089 (JP 2015-149089 A) discloses a technique in which a notification instructing to support checkout work is given at a store to engage other store employee(s) in assistance work to assist store employees operating cash register devices.

### SUMMARY

However, the above technique is limited to support within the same store.

The present disclosure provides a control device, a system, a vehicle, and a service support method that allow support between different facilities.

A first aspect of the present disclosure relates to a control device. The control device includes a control unit configured to acquire status data indicating status of a first facility and to determine according to the status indicated by the acquired status data whether to send resources possessed by a second facility different from the first facility from the second facility to the first facility as resources to be used to provide a service at the first facility.

In the first aspect, the status data may include data indicating as the status whether the first facility has sufficient resources required to provide the service.

In the above aspect, the status data may include data indicating as the status how crowded the first facility is.

In the above aspect, the status data may include data indicating as the status whether a visitor to the first facility desires a first service provided by the first facility. The control unit may be configured to determine according to the status whether to send the resources possessed by the second facility as resources to be used to provide a second service different from the first service.

In the above aspect, the service may include a service of serving food. The control unit may be configured to determine according to the status whether to send ingredients possessed by the second facility as the resources to be used to provide the service.

In the above aspect, the control unit may be configured to determine according to the status whether to send staff possessed by the second facility as the resources to be used to provide the service.

In the above aspect, the control unit may be configured to determine according to the status whether to send staff possessed by the second facility in order to provide a second service different from a first service provided by the first facility as resources to be used to provide the first service.

In the above aspect, the control device may further include a communication unit configured to, when the control unit determines to send the staff, send content for teaching the staff a method for providing the first service to a vehicle, the vehicle being configured to send the staff from the second facility to the first facility.

In the above aspect, the first service and the second service may include services of providing different foods from each other. The method for providing the first service may include how to make food that is provided by the first service.

A second aspect of the present disclosure relates to a system. The system includes: the control device of the above aspect; and a vehicle configured to, when the control unit determines to send the resources possessed by the second facility, send the resources from the second facility to the first facility.

A third aspect of the present disclosure relates to a system. The system includes the control device of the above aspect and the vehicle of the above aspect.

A fourth aspect of the present disclosure relates to a vehicle. The vehicle includes a control unit configured to, when a control device determines according to status of a first facility to send staff possessed by a second facility in order to provide a second service different from a first service provided by the first facility from the second facility to the first facility as resources to be used to provide the first service, perform a control to send the staff from the second facility to the first facility.

In the fourth aspect, the vehicle may further include: a communication unit that receives, when the control device determines to send the staff, content for teaching the staff a method for providing the first service from the control device; and an output unit that outputs the content received by the communication unit.

In the above aspect, the first service and the second service may include services of providing different foods from each other. The method for providing the first service may include how to make food that is provided by the first service.

In the above aspect, a space may be provided for the staff to change into a uniform of the first facility.

In the above aspect, a change in appearance of the vehicle may occur while the vehicle is traveling from the second facility to the first facility.

In the above aspect, a display of the vehicle may be mounted on an exposed surface of the vehicle. The change in appearance may include a change of the display from displaying a trademark of the second facility to displaying a trademark of the first facility.

A fifth aspect of the present disclosure relates to a service support method. The service support method includes: determining according to status of a first facility by a control device whether to send resources possessed by a second facility different from the first facility from the second facility to the first facility as resources to be used to provide a service at the first facility; and sending the resources from the second facility to the first facility by a vehicle when the control device determines to send the resources possessed by the second facility.

In the fifth aspect, the service may include a service of serving food. The determining may include determining according to the status whether to send ingredients possessed by the second facility as the resources to be used to provide the service.

In the fifth aspect, the determining may include determining according to the status whether to send staff possessed by the second facility as the resources to be used to provide the service.

According to each aspect of the present disclosure, support between different facilities becomes possible.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 illustrates a configuration of a system according to an embodiment of the present disclosure;

FIG. 2 is a block diagram illustrating a configuration of a control device according to the embodiment of the present disclosure;

FIG. 3 is a block diagram illustrating a configuration of a vehicle according to the embodiment of the present disclosure;

FIG. 4 is a flowchart illustrating the operation of the control device according to the embodiment of the present disclosure; and

FIG. 5 is a flowchart illustrating the operation of the vehicle according to the embodiment of the present disclosure.

### DETAILED DESCRIPTION OF EMBODIMENTS

An embodiment of the present disclosure will be described with reference to the drawings.

The same or corresponding parts are denoted by the same signs throughout the figures. In the embodiment, description of the same or corresponding parts will be omitted or simplified as appropriate.

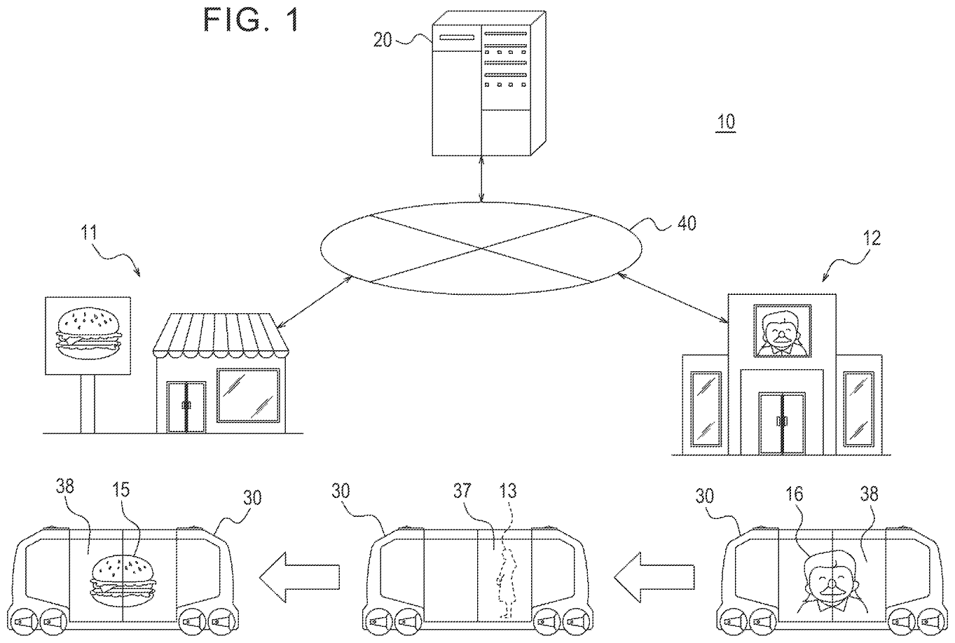

The outline of the embodiment will be described with reference to FIG. 1.

In the embodiment, a control device 20 determines according to the status of a first facility 11 whether to send resources possessed by a second facility 12 different from the first facility 11 from the second facility 12 to the first facility 11 as resources to be used to provide a service at the first facility 11. When the control device 20 determines to send the resources possessed by the second facility 12, the resources are sent from the second facility 12 to the first facility 11 by a vehicle 30. Support between different facilities thus becomes possible.

The first facility 11 and the second facility 12 may originally provide the same service. In the embodiment, however, the first facility 11 provides a first service and the second facility 12 provides a second service different from the first service. When the first facility 11 receives support from the second facility 12, the first facility 11 may provide the same service as the second facility 12, that is, the second service.

In the embodiment, the first service and the second service include services that provide different foods from each other. Specifically, the first service includes a service that provides hamburgers. The second service includes a service that provides fried chicken. For example, the first facility 11 is a hamburger chain store. The second facility 12 is a fried chicken chain store. The second facility 12 possesses various resources including staff 13 such as cooking staff and customer service staff and ingredients such as chicken breasts and chicken thighs in order to provide the second service.

In the embodiment, whether the first facility 11 has sufficient resources required to provide the service is taken into consideration as the status of the first facility 11. Alternatively, how crowded the first facility 11 is taken into consideration as the status of the first facility 11. For example, it is assumed that the first facility 11 does not have enough cooking staff and customer service staff or that the first facility 11 is crowded. In this case, it is determined that available cooking staff and customer service staff of the second facility 12 are sent as resources to be used to provide foods such as hamburgers at the first facility 11. The cooking staff is sent from the second facility 12 to the first facility 11 to make foods at the first facility 11. The customer service staff is sent from the second facility 12 to the first facility 11 to take food orders at the first facility 11. As a result, it is expected that the staffing shortage of the first facility 11 will be resolved. Alternatively, it is expected that the manpower of the first facility 11 will be increased and customer wait times will be reduced.

In the embodiment, the vehicle 30 has a space 37 for the staff 13 to change into a uniform of the first facility 11. For example, the cooking staff and the customer service staff change from a uniform of the second facility 12 to the uniform of the first facility 11 in the space 37 within the vehicle 30 while traveling from the second facility 12 to the first facility 11. The cooking staff may receive training in the vehicle 30 on a method for providing the first service, including how to make foods that are provided by the first service, while or after changing into the uniform of the first facility 11. The customer service staff may receive training in the vehicle 30 on the method for providing the first service, including how to take orders for foods that are provided by the first service, while or after changing into the uniform of the first facility 11.

In the embodiment, a change in the appearance of the vehicle 30 occurs while the vehicle 30 is traveling from the second facility 12 to the first facility 11. The change in appearance includes a change of a display 38 mounted on an exposed surface of the vehicle 30 from displaying a trademark 16 of the second facility 12 to displaying a trademark 15 of the first facility 11. For example, the trademark 16 of the second facility 12 is displayed on the display 38 when the vehicle 30 with the cooking staff and the customer service staff departs from the second facility 12. The display 38 switches from the trademark 16 of the second facility 12 to the trademark 15 of the first facility 11 when the cooking staff and the customer service staff finish changing into the uniform of the first facility 11, when the cooking staff and the customer service staff finish receiving training on the method for providing the first service, or at any other time. The trademark 15 of the first facility 11 will have been displayed on the display 38 when the vehicle 30 arrives at the first facility 11. As a result, it is expected that when the cooking staff and the customer service staff get out of the vehicle 30, they will have had a sense of belonging to the first facility 11 and will have been more motivated to support the first facility 11. Moreover, even when a customer sees the vehicle 30 at the first facility 11 or sees the cooking staff or the customer service staff getting out of the vehicle 30 at the first facility 11, the customer is less likely to feel uneasy or suspicious.

The change in appearance of the vehicle 30 is not limited to switching of the trademark displayed on the display 38, but may be any change such as switching of any character(s), figure(s), or image(s) displayed on the display 38, or deformation of a vehicle body of the vehicle 30.

Whether a visitor to the first facility 11 desires the first service may be taken into consideration as the status of the first facility 11. For example, it is assumed that a customer visiting the first facility 11 does not want to eat any food on the menu of the first facility 11 such as a hamburger. In this case, it is determined to send available cooking staff of the second facility 12 and surplus ingredients available at the second facility 12 as resources to be used at the first facility 11 to provide foods that are not on the menu of the first facility 11 such as fried chicken. The cooking staff is sent from the second facility 12 to the first facility 11 together with the ingredients, and at the first facility 11, makes the foods that are not on the menu using the ingredients. The customer can thus eat the foods that are not on the menu of the first facility 11.

The services provided by the first facility 11 and the second facility 12 are not limited to the food services, but may be any services such as medical services, nursing care services, accommodation services, financial services, leisure services, and educational services. The first facility 11 and the second facility 12 are not limited to the restaurants, but may be any facilities such as medical facilities like clinics or hospitals, nursing facilities, accommodation facilities like hotels, banks, leisure facilities, or educational facilities.

As a modification of the embodiment, the first service may include an adult medical service. The second service may include a pediatric medical service. For example, the first facility 11 may be an adult clinic. The second facility 12 may be a pediatric clinic. The second facility 12 may possess various resources including the staff 13 such as a pediatrician in order to provide the second service.

In this modification as well, whether the first facility 11 has sufficient resources required to provide the service is taken into consideration as the status of the first facility 11. Alternatively, how crowded the first facility 11 is taken into consideration as the status of the first facility 11. For example, it is assumed that the first facility 11 does not have enough doctors or that the first facility 11 is crowded. In this case, it is determined to send an available pediatrician(s) of the second facility 12 as resources to be used to provide medical care to adult patients at the first facility 11. The pediatrician(s) is sent from the second facility 12 to the first facility 11 to provide medical care to patients at the first facility 11. As a result, it is expected that the staffing shortage of the first facility 11 will be resolved. Alternatively, it is expected that the manpower of the first facility 11 will be increased and patient wait times will be reduced.

The configuration of a system 10 according to the embodiment will be described with reference to FIG. 1.

The system 10 includes at least one control device 20 and at least one vehicle 30.

The control device 20 is installed in a facility such as a data center. The control device 20 is a computer such as a server belonging to a cloud computing system or other computing system.

The vehicle 30 is any type of automobile such as gasoline vehicle, diesel vehicle, HV, PHV, EV, or FCV. HV stands for hybrid vehicle. PHV stands for plug-in hybrid vehicle. EV stands for electric vehicle. FCV stands for fuel cell vehicle. Although the vehicle 30 is an AV in the embodiment, the vehicle 30 may be driven by a driver or driving may be automated at any level. AV stands for autonomous vehicle. The level of driving autonomous is, e.g., any one of SAE Levels 1 to 5. SAE stands for the Society of Automotive Engineers. The vehicle 30 may be a MaaS-dedicated vehicle. MaaS stands for Mobility as a Service.

The display 38 is mounted on the exposed surface of the vehicle 30. Although the display 38 is mounted on a side of the vehicle 30 in the embodiment, the display 38 may be mounted on any exposed surface such as the top of the vehicle 30. Although the display 38 is a built-in display in a door of the vehicle 30 in the embodiment, the display 38 may be mounted on a surface of the door or at a position away from the door. The display 38 is, e.g., an LCD or an organic EL display. LCD stands for liquid crystal display. EL stands for electro luminescence.

The control device 20 can communicate with the vehicle 30 via a network 40. The control device 20 can also communicate with a terminal device of the first facility 11 and a terminal device of the second facility 12 via the network 40.

The network 40 includes the Internet, at least one WAN, at least one MAN, or any combination thereof. WAN stands for wide area network. MAN stands for metropolitan area network. The network 40 may include at least one wireless network, at least one optical network, or any combination thereof. The wireless network is, e.g., an ad hoc network, a cellular network, a wireless LAN, a satellite communication network, or a terrestrial microwave network. LAN stands for local area network.

The terminal device of the first facility 11 is installed in the first facility 11 or is held by management staff of the first facility 11. The terminal device of the first facility 11 is, e.g., a mobile device such as mobile phone, smartphone, or tablet, or a PC. PC stands for personal computer.

The terminal device of the second facility 12 is installed in the second facility 12 or is held by management staff of the second facility 12. The terminal device of the second facility 12 is, e.g., a mobile device such as mobile phone, smartphone, or tablet, or a PC.

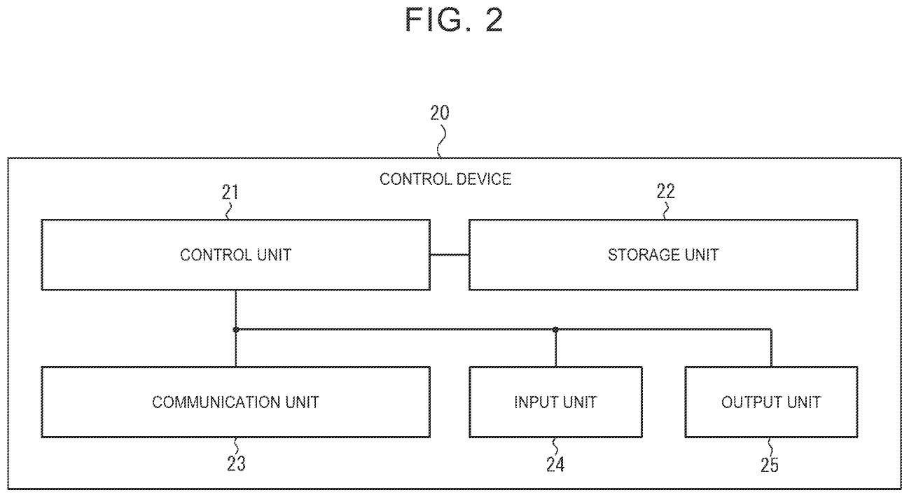

The configuration of the control device 20 according to the embodiment will be described with reference to FIG. 2.

The control device 20 includes a control unit 21, a storage unit 22, a communication unit 23, an input unit 24, and an output unit 25.

The control unit 21 includes at least one processor, at least one programmable circuit, at least one dedicated circuit, or any combination thereof. The processor is a general-purpose processor such as CPU or GPU, or a dedicated processor specialized for a specific process. CPU stands for central processing unit. GPU stands for graphics processing unit. The programmable circuit is, e.g., an FPGA. FPGA stands for field-programmable gate array. The dedicated circuit is, e.g., an ASIC. ASIC stands for application specific integrated circuit. The control unit 21 execute processes related to the operation of the control device 20 while controlling each unit of the control device 20.

The storage unit 22 includes at least one semiconductor memory, at least one magnetic memory, at least one optical memory, or any combination thereof. The semiconductor memory is, e.g., a RAM or a ROM. RAM stands for random access memory. ROM stands for read only memory. The RAM is, e.g., an SRAM or a DRAM. SRAM stands for static random access memory. DRAM stands for dynamic random access memory. The ROM is, e.g., an EEPROM. EEPROM stands for electrically erasable programmable read only memory. The storage unit 22 functions as, e.g., a main storage device, an auxiliary storage device, or a cache memory. The storage unit 22 stores data to be used for the operation of the control device 20 and data obtained by the operation of the control device 20.

The communication unit 23 includes at least one communication interface. The communication interface is, e.g., a LAN interface. The communication unit 23 receives the data to be used for the operation of the control device 20, and sends the data obtained by the operation of the control device 20.

The input unit 24 includes at least one input interface. The input interface is, e.g., a physical key, a capacitive key, a pointing device, a touch screen integrated with a display, a camera, or a microphone. The input unit 24 accepts an operation of entering the data to be used for the operation of the control device 20. The input unit 24 may be an external input device connected to the control device 20, instead of being provided in the control device 20. Any method such as, e.g., USB, HDMI (registered trademark), or Bluetooth (registered trademark) can be used as a connection method. USB stands for Universal Serial Bus. HDMI (registered trademark) stands for High-Definition Multimedia interface.

The output unit 25 includes at least one output interface. The output interface is, e.g., a display or a speaker. The display is, e.g., an LCD or an organic EL display. The output unit 25 outputs the data obtained by the operation of the control device 20. The output unit 25 may be an external output device connected to the control device 20, instead of being provided in the control device 20. Any method such as, e.g., USB, HDMI (registered trademark), or Bluetooth (registered trademark) can be used as a connection method.

The functions of the control device 20 are implemented by executing a first control program according to the embodiment by a processor serving as the control unit 21. That is, the functions of the control device 20 are implemented by software. The first control program causes a computer to perform the operation of the control device 20 such that the computer functions as the control device 20. That is, the computer functions as the control device 20 by performing the operation of the control device 20 according to the first control program.

The program can be stored in a non-transitory computer-readable medium. The non-transitory computer-readable medium is, e.g., a flash memory, a magnetic recording device, an optical disc, an opto-magnetic recording medium, or a ROM. The program is distributed by, e.g., selling, transferring, or renting a portable medium storing the program, such as SD card, DVD, or CD-ROM. SD stands for Secure Digital. DVD stands for digital versatile disc. CD-ROM stands for compact disc read only memory. The program may be distributed by storing the program in a storage of a server and transferring the program from the server to other computers. The program may be provided as a program product.

For example, the computer first stores in a main storage device the program stored in the portable medium or the program transferred from the server. The computer then causes a processor to read the program stored in the main storage device, and causes the processor to execute processes according to the read program. The computer may read the program directly from the portable medium and execute processes according to the program. The computer may execute processes according to the received program every time the program is transferred from the server to the computer. The program may not be transferred from the server to the computer, and processes may be executed by what is called an ASP service that implements the functions only by execution instructions and acquisition of results. ASP stands for application service provider. The program includes information that is provided for processing by an electronic computer and that is equivalent to the program. For example, data that is not a direct command to the computer but has the property of defining the processing of the computer is the “information equivalent to the program”.

A part or all of the functions of the control device 20 may be implemented by a programmable circuit or dedicated circuit that serves as the control unit 21. That is, a part or all of the functions of the control device 20 may be implemented by hardware.

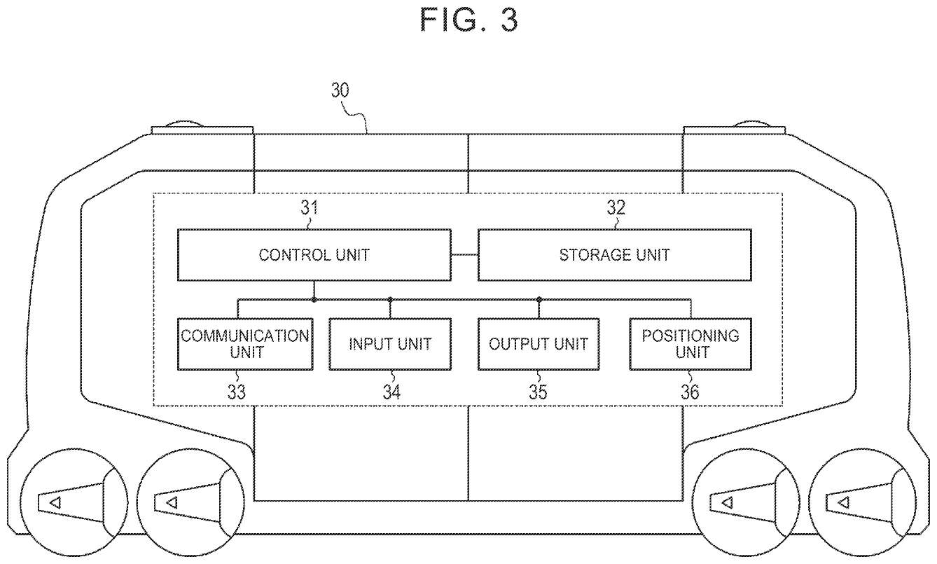

The configuration of the vehicle 30 according to the embodiment will be described with reference to FIG. 3.

The vehicle 30 includes a control unit 31, a storage unit 32, a communication unit 33, an input unit 34, an output unit 35, and a positioning unit 36.

The control unit 31 includes at least one processor, at least one programmable circuit, at least one dedicated circuit, at least one ECU, or any combination thereof. ECU stands for electronic control unit. The processor is a general-purpose processor such as CPU or GPU, or a dedicated processor specialized for a specific process. The programmable circuit is, e.g., an FPGA. The dedicated circuit is, e.g., an ASIC. The control unit 31 execute processes related to the operation of the vehicle 30 while controlling each unit of the vehicle 30.

The storage unit 32 includes at least one semiconductor memory, at least one magnetic memory, at least one optical memory, or any combination thereof. The semiconductor memory is, e.g., a RAM or a ROM. The RAM is, e.g., an SRAM or a DRAM. The ROM is, e.g., an EEPROM. The storage unit 32 functions as, e.g., a main storage device, an auxiliary storage device, or a cache memory. The storage unit 32 stores data to be used for the operation of the vehicle 30 and data obtained by the operation of the vehicle 30.

The communication unit 33 includes at least one communication interface. The communication interface is, e.g., an interface compatible with mobile communication standards such as LTE, 4G standards, or 5G standards, an interface compatible with short-range wireless communication such as Bluetooth (registered trademark), or a LAN interface. LTE stands for Long Term Evolution. 4G stands for fourth generation. 5G stands for fifth generation. The communication unit 33 receives the data to be used for the operation of the vehicle 30, and sends the data obtained by the operation of the vehicle 30.

The input unit 34 includes at least one input interface. The input interface is, e.g., a physical key, a capacitive key, a pointing device, a touch screen integrated with a display, a camera, or a microphone. The input unit 34 accepts an operation of entering the data to be used for the operation of the vehicle 30. The input unit 34 may be an external input device connected to the vehicle 30, instead of being provided in the vehicle 30. Any method such as, e.g., USB, HDMI (registered trademark), or Bluetooth (registered trademark) can be used as a connection method.

The output unit 35 includes at least one output interface. The output interface is, e.g., a display or a speaker. The display is, e.g., an LCD or an organic EL display. The output unit 35 outputs the data obtained by the operation of the vehicle 30.

The output unit 35 may be an external output device connected to the vehicle 30, instead of being provided in the vehicle 30. Any method such as, e.g., USB, HDMI (registered trademark), or Bluetooth (registered trademark) can be used as a connection method.

The positioning unit 36 includes at least one GNSS receiver. GNSS stands for global navigation satellite system. The GNSS is, e.g., GPS, QZSS, BDS, GLONASS, or Galileo. GPS stands for Global Positioning System. QZSS stands for Quasi-Zenith Satellite System. Satellites of the QZSS are called quasi-zenith satellites. BDS stands for BeiDou Navigation Satellite System. GLONASS stands for Global Navigation Satellite System. The positioning unit 36 measures the position of the vehicle 30.

The control unit 31, the storage unit 32, the communication unit 33, the input unit 34, the output unit 35, and the positioning unit 36 may be provided in the vehicle 30 by being individually incorporated into the vehicle 30. Alternatively, the control unit 31, the storage unit 32, the communication unit 33, the input unit 34, the output unit 35, and the positioning unit 36 may be incorporated into at least one in-vehicle device, and the in-vehicle device may be provided in the vehicle 30.

The functions of the in-vehicle device are implemented by executing a second control program according to the embodiment by a processor serving as the control unit 31. That is, the functions of the in-vehicle device are implemented by software. The second control program causes a computer to perform the operation of the in-vehicle device such that the computer functions as the in-vehicle device. That is, the computer functions as the in-vehicle device by performing the operation of the in-vehicle device according to the second control program.

A part or all of the functions of the in-vehicle device may be implemented by a programmable circuit or dedicated circuit that serves as the control unit 31. That is, a part or all of the functions of the in-vehicle device may be implemented by hardware.

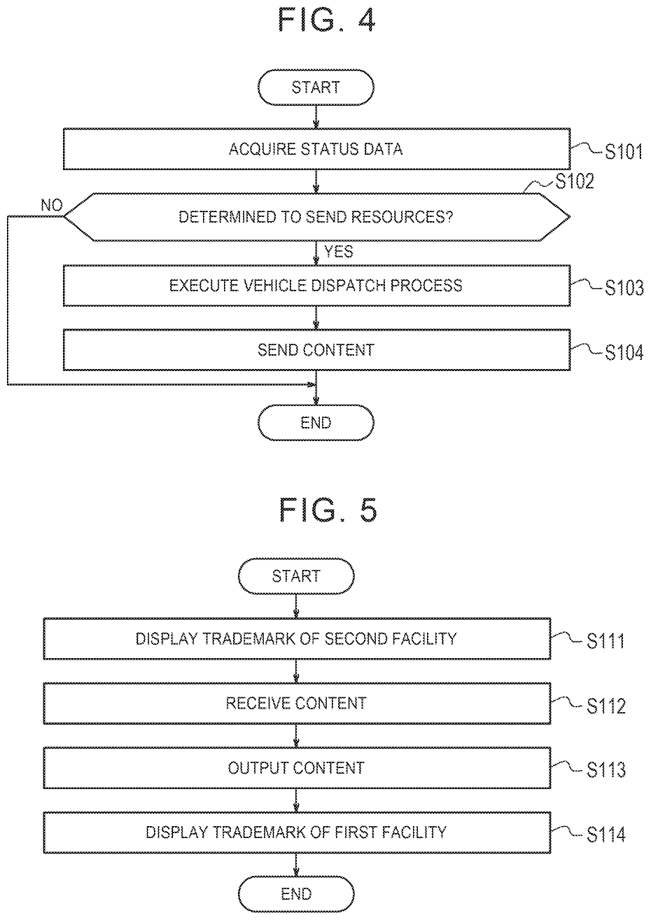

The operation of the system 10 according to the embodiment will be described with reference to FIGS. 4 and 5. This operation corresponds to a service support method according to the embodiment. FIG. 4 illustrates the operation of the control device 20. FIG. 5 illustrates the operation of the vehicle 30.

In step S101 of FIG. 4, the control unit 21 of the control device 20 acquires status data. The status data is data showing the status of the first facility 11. In the embodiment, the status data includes data indicating as the status of the first facility 11 whether the first facility 11 has sufficient resources required to provide the service. Alternatively, the status data includes data indicating as the status of the first facility 11 how crowded the first facility 11 is.

Although the status data may be acquired by any procedure, the status data is acquired by the following procedure in the embodiment.

The communication unit 23 of the control device 20 receives from the terminal device of the first facility 11 the status data entered by the management staff of the first facility 11. The control unit 21 of the control device 20 acquires the status data received by the communication unit 23.

The control device 20 may generate the status data instead of receiving the status data from the terminal device of the first facility 11. In such a modification, the communication unit 23 of the control device 20 receives from the terminal device of the first facility 11 an image captured by a camera installed in the first facility 11. The control unit 21 of the control device 20 analyzes the image received by the communication unit 23 to determine whether the first facility 11 has sufficient resources required to provide the service or how crowded the first facility 11 is. The control unit 21 then acquires the determination result as the status data.

In step S102 of FIG. 4, the control unit 21 of the control device 20 determines according to the status indicated by the status data acquired in step S101 whether to send the resources possessed by the second facility 12 from the second facility 12 to the first facility 11 as resources to be used to provide the service at the first facility 11. That is, the control unit 21 determines according to the status of the first facility 11 whether to support the first facility 11. When the control unit 21 determines to send the resources possessed by the second facility 12, that is, determines to support the first facility 11, the routine proceeds to step S103. When the control unit 21 determines not to send the resources possessed by the second facility 12, that is, determines not to support the first facility 11, the flow of FIG. 4 ends.

Specifically, the control unit 21 of the control device 20 determines according to the status indicated by the status data whether to send the staff 13 possessed by the second facility 12 as resources to be used to provide the service. In the embodiment, the control unit 21 determines according to the status indicated by the status data whether to send the staff 13 possessed by the second facility 12 in order to provide the second service different from the first service provided at the first facility 11 as resources to be used to provide the first service.

For example, it is assumed that the first facility 11 does not have enough cooking staff and customer service staff or that the first facility 11 is crowded. In this case, the control unit 21 of the control device 20 determines to send available cooking staff and customer service staff of the second facility 12 as resources to be used to provide foods such as hamburgers at the first facility 11. The available cooking staff and customer service staff of the second facility 12 may be identified by any method. For example, the control unit 21 identifies the available cooking staff and customer service staff of the second facility 12 by referring to data about the cooking staff and customer service staff entered by the management staff of the second facility 12. Alternatively, the control unit 21 analyzes an image captured by a camera installed in the second facility 12 to identify the available cooking staff and customer service staff of the second facility 12.

In step S103 of FIG. 4, the control unit 21 of the control device 20 executes a vehicle dispatch process of the vehicle 30.

Although the vehicle dispatch process may be executed by any procedure, the vehicle dispatch process is executed by the following procedure in the embodiment.

The control unit 21 of the control device 20 causes the communication unit 23 to send a vehicle dispatch request. The communication unit 23 sends the vehicle dispatch request to the vehicle 30. The communication unit 33 of the vehicle 30 receives the vehicle dispatch request sent from the control device 20. In response to the vehicle dispatch request received by the communication unit 33, the control unit 31 of the vehicle 30 performs a control to pick up at the second facility 12 the staff 13 determined in step S102 to be sent as resources to be used to provide the service. The control unit 31 of the vehicle 30 then performs a control to send the picked-up staff 13 from the second facility 12 to the first facility 11. According to this series of controls, the vehicle 30 picks up the staff 13 at the second facility 12 and drives the picked-up staff 13 from the second facility 12 to the first facility 11.

In step S104 of FIG. 4, the control unit 21 of the control device 20 causes the communication unit 23 to send content for teaching the staff 13 the method for providing the first service. The content is stored in advance in the storage unit 22 of the control device 20 or an external storage. The communication unit 23 sends the content to the vehicle 30.

For example, it is assumed that the control unit 21 of the control device 20 determines in step S102 to send available cooking staff and customer service staff of the second facility 12 as resources to be used to provide foods such as hamburgers at the first facility 11. In this case, the control unit 21 of the control device 20 causes the communication unit 23 to send a training video on the method for providing the first service, including how to make foods that are provided by the first service and how to take orders for foods that are provided by the first service.

In step S111 of FIG. 5, the control unit 31 of the vehicle 30 performs a control to display the trademark 16 of the second facility 12. The display 38 displays the trademark 16 of the second facility 12 according to this control. Step S111 is started at the latest when the vehicle 30 picks up the staff 13 at the second facility 12 and is continued at least until the vehicle 30 with the staff 13 departs from the second facility 12.

In the embodiment, the vehicle dispatch request sent in step S103 of FIG. 4 includes a request to display the trademark 16 of the second facility 12. In response to this request, the control unit 31 of the vehicle 30 performs a control to display the trademark 16 of the second facility 12.

In step S112 of FIG. 5, the communication unit 33 of the vehicle 30 receives the content sent in step S104 of FIG. 4 from the control device 20.

In step S113 of FIG. 5, the control unit 31 of the vehicle 30 performs a control to output the content received in step S112. The output unit 35 of the vehicle 30 outputs the content according to this control. Step S113 is performed between the time the vehicle 30 with the staff 13 departs from the second facility 12 and the time the vehicle 30 arrives at the first facility 11.

For example, it is assumed that the training video on the method for providing the first service is sent in step S104 of FIG. 4. In this case, the display serving as the output unit 35 of the vehicle 30 displays on its screen an image included in the training video to the cooking staff and customer service staff in the space 37 in the vehicle 30. The speaker serving as the output unit 35 outputs a voice included in the training video to the cooking staff and customer service staff.

In step S114 of FIG. 5, the control unit 31 of the vehicle 30 performs a control to display the trademark 15 of the first facility 11. The display 38 displays the trademark 15 of the first facility 11 according to this control. Step S114 is started before the vehicle 30 with the staff 13 arrives at the first facility 11 and is continued at least until the vehicle 30 arrives at the first facility 11.

In the embodiment, the vehicle dispatch request sent in step S103 of FIG. 4 includes a request to switch from displaying the trademark 16 of the second facility 12 to displaying the trademark 15 of the first facility 11 while the vehicle 30 is traveling from the second facility 12 to the first facility 11. In response to this request, the control unit 31 of the vehicle 30 performs a control to display the trademark 15 of the first facility 11.

As described above, in the embodiment, the control unit 21 of the control device 20 acquires the status data indicating the status of the first facility 11. The control unit 21 determines according to the status indicated by the acquired status data whether to send the resources possessed by the second facility 12 different from the first facility 11 from the second facility 12 to the first facility 11 as resources to be used to provide the service at the first facility 11.

According to the embodiment, the resources possessed by the second facility 12 can be rented or provided to the first facility 11. That is, support between different facilities is possible.

In the embodiment, when the control device 20 determines to send the staff 13 possessed by the second facility 12 in order to provide the second service different from the first service provided at the first facility 11 from the second facility 12 to the first facility 11 as resources to be used to provide the first service, the control unit 31 of the vehicle 30 performs a control to send the staff 13 from the second facility 12 to the first facility 11.

According to the embodiment, the manpower of the first facility 11 can be increased by the support from the second facility 12.

For example, it is assumed that there is a restaurant with many seats, but the food is slow to arrive because of so many orders. According to the embodiment, sending support from another restaurant to this restaurant allows this restaurant to serve food quickly. Moreover, each restaurant may be crowded at a different time of the day. According to the embodiment, available resources can be effectively used by sending support from an uncrowded restaurant to a crowded restaurant.

Information on resources such as the number of employees and information on how crowded the restaurant is such as seat availability and order status may be shared between or among restaurants of the same chain such that the restaurants of the same chain can support each other. Alternatively, information on resources and information on how crowded the restaurant is may be shared between or among restaurants of different chains such that the restaurants of different chains can support each other. A common attendance management system may be introduced to restaurants. In the case where a person is dispatched as resources, a restaurant that accepted the dispatched person may pay the person for the time the person worked at this restaurant. In this case, a restaurant that dispatched the person can reduce labor costs.

As a modification of the embodiment, the status data may include data indicating as the status of the first facility 11 whether a visitor to the first facility 11 desires the first service. In such a modification, the control unit 21 of the control device 20 determines according to the status indicated by the status data whether to send the resources possessed by the second facility 12 as resources to be used to provide the second service.

For example, it is assumed that a customer visiting the first facility 11 does not want to eat any food on the menu of the first facility 11 such as a hamburger. In this case, the control unit 21 of the control device 20 determines to send available cooking staff of the second facility 12 as resources to be used to provide foods that are not on the menu of the first facility 11, such as fried chicken, at the first facility 11.

For example, it is assumed that there is a restaurant with a nice atmosphere but a customer does not like the restaurant's menu. According to this modification, sending support from another restaurant to this restaurant allows this restaurant to provide foods that are not on the menu.

Wait times may be shown on the menu. In the case where a customer visiting the restaurant orders food of the other restaurant, the restaurant may collect a place fee from the other restaurant.

As a modification of the embodiment, the control unit 21 of the control device 20 may determine according to the status indicated by the status data whether to send the ingredients possessed by the second facility 12 as resources to be used to provide the service.

For example, it is assumed that a customer visiting the first facility 11 does not want to eat any food on the menu of the first facility 11 such as a hamburger. In this case, the control unit 21 of the control device 20 determines to send surplus ingredients available at the second facility 12 as resources to be used at the first facility 11 to provide foods that are not on the menu of the first facility 11 such as fried chicken.

Instead of sending the ingredients as they are, foods containing the ingredients may be sent. Food preparation may be carried out while the vehicle 30 is traveling from the second facility 12 to the first facility 11.

The present disclosure is not limited to the above embodiment. For example, a plurality of blocks shown in the block diagram may be integrated into one block, or a block may be divided into a plurality of sub-blocks. Instead of performing the steps shown in the flowchart in chronological order according to the description, the steps may be performed in parallel or in a different order according to the processing capacity of the device that performs each step or as necessary. Other modifications can be made without departing from the spirit and scope of the present disclosure.

For example, the control device 20 may be installed in the first facility 11. In this case, the terminal device of the first facility 11 may be integrated into the control device 20.

Alternatively, the control device 20 may be installed in the second facility 12. In this case, the terminal device of the second facility 12 may be integrated into the control device 20.

Alternatively, the control device 20 may be mounted or installed in the vehicle 30. In this case, at least a part of the operation of the vehicle 30 may be performed by the control device 20. In the case where the control unit 31, the storage unit 32, the communication unit 33, the input unit 34, the output unit 35, and the positioning unit 36 of the vehicle 30 are incorporated into the in-vehicle device, the in-vehicle device may be integrated into the control device 20.

What is claimed is:

1. A control device, comprising a control unit configured to acquire status data indicating status of a first facility and to determine according to the status indicated by the acquired status data whether to send resources possessed by a second facility different from the first facility, from the second facility to the first facility, as resources to be used to provide a service at the first facility.

2. The control device according to claim 1, wherein the status data includes data indicating as the status whether the first facility has sufficient resources required to provide the service.

3. The control device according to claim 1, wherein the status data includes data indicating as the status how crowded the first facility is.

4. The control device according to claim 1, wherein:
the status data includes data indicating as the status whether a visitor to the first facility desires a first service provided by the first facility; and
the control unit is configured to determine according to the status whether to send the resources possessed by the second facility as resources to be used to provide a second service different from the first service.

5. The control device according to claim 1, wherein:
the service includes a service of serving food; and
the control unit is configured to determine according to the status whether to send ingredients possessed by the second facility as the resources to be used to provide the service.

6. The control device according to claim 1, wherein the control unit is configured to determine according to the status whether to send staff possessed by the second facility as the resources to be used to provide the service.

7. The control device according to claim 1, wherein the control unit is configured to determine according to the status whether to send staff possessed by the second facility in order to provide a second service different from a first service provided by the first facility as resources to be used to provide the first service.

8. The control device according to claim 7, further comprising a communication unit configured to, when the control unit determines to send the staff, send content for teaching the staff a method for providing the first service to a vehicle, the vehicle being configured to send the staff from the second facility to the first facility.

9. The control device according to claim 8, wherein:
the first service and the second service include services of providing different foods from each other; and
the method for providing the first service includes how to make food that is provided by the first service.

10. A system, comprising:
the control device according to claim 1; and
a vehicle configured to, when the control unit determines to send the resources possessed by the second facility, send the resources from the second facility to the first facility.

11. A system, comprising:
the control device according to claim 8; and
the vehicle.

12. A vehicle, comprising a control unit configured to, when a control device determines according to status of a first facility to send staff possessed by a second facility in order to provide a second service different from a first service provided by the first facility, from the second facility to the first facility, as resources to be used to provide the first service, perform a control to send the staff from the second facility to the first facility.

13. The vehicle according to claim 12, further comprising:
a communication unit that receives, when the control device determines to send the staff, content for teaching the staff a method for providing the first service from the control device; and
an output unit that outputs the content received by the communication unit.

14. The vehicle according to claim 13, wherein:
the first service and the second service include services of providing different foods from each other; and
the method for providing the first service includes how to make food that is provided by the first service.

15. The vehicle according to claim 12, wherein a space is provided for the staff to change into a uniform of the first facility.

16. The vehicle according to claim 12, wherein a change in appearance of the vehicle occurs while the vehicle is traveling from the second facility to the first facility.

17. The vehicle according to claim 16, wherein:
a display of the vehicle is mounted on an exposed surface of the vehicle; and
the change in appearance includes a change of the display from displaying a trademark of the second facility to displaying a trademark of the first facility.

18. A service support method, comprising:
determining according to status of a first facility by a control device whether to send resources possessed by a second facility different from the first facility, from the second facility to the first facility, as resources to be used to provide a service at the first facility; and
sending the resources from the second facility to the first facility by a vehicle when the control device determines to send the resources possessed by the second facility.

19. The service support method according to claim 18, wherein:
the service includes a service of serving food; and
the determining includes determining according to the status whether to send ingredients possessed by the second facility as the resources to be used to provide the service.

20. The service support method according to claim 18, wherein the determining includes determining according to the status whether to send staff possessed by the second facility as the resources to be used to provide the service.
